(19) United States
(12) Patent Application Publication
(10) Pub. No.: US 2019/0073700 A1
(43) Pub. Date: Mar. 7, 2019

(54) VIRTUAL HOME MAIL BOX DRIVEN COMMUNICATION SYSTEM AND METHODS EMPLOYED THEREOF

(71) Applicants: Moses Israel Mesa, Mason, OH (US); Harikrishna Allam, Sharon, MA (US); Sandeep Allam, Carmel, IN (US); Feroz Syed, Carmel, IN (US)

(72) Inventors: Moses Israel Mesa, Mason, OH (US); Harikrishna Allam, Sharon, MA (US); Sandeep Allam, Carmel, IN (US); Feroz Syed, Carmel, IN (US)

(21) Appl. No.: 15/694,754

(22) Filed: Sep. 1, 2017

(51) Int. Cl. G06Q 30/02

(52) U.S. Cl. CPC G06Q 30/0277; G06Q 30/0261; G06Q 30/0248; G06Q 30/0242; G06Q 30/0269

(57) ABSTRACT

Exemplary embodiments of the present disclosure are directed towards a system and method for facilitating communications in real time. The system comprising a plurality of consumer computing devices and a plurality of business organization computing devices configured to create a plurality of virtual home mail boxes by a plurality of consumers and a plurality of business organizations with a virtual home mail box driven system, the created plurality of virtual home mail boxes are configured to allow a plurality of communications between the plurality of consumers to the plurality of business organizations, the plurality of business organizations to the plurality of consumers, the plurality of consumers to the plurality of consumers and the plurality of business organizations to the plurality of business organizations. The virtual home mail box driven system further comprises of: an offer managing module configured to capture a plurality of requests from the plurality of consumers and alert the plurality of consumers with a plurality of custom offers with and without geographic location limitations by a plurality of business organizations, wherein the plurality of business organizations are configured to reach out to the plurality of consumers with the plurality of custom offers through the offer managing module. A digital home mail box providing module configured to deliver a plurality of secure mails to the plurality of consumer computing devices and the plurality of business organization computing devices. A metadata providing module configured to provide metadata to the plurality of consumer computing devices and the plurality of business organization computing devices through the plurality of virtual home mail boxes, whereby the metadata is collected by at least one database, and a common component assigning module configured to provide a foundation framework for generating at least one of a plurality of alerts, a plurality of rules, a plurality of reports and a plurality of analytics to the plurality of consumer computing devices and the plurality of business organization computing devices.

### CROSS REFERENCES

This application claims priority of U.S. Provisional application No. 62/382,259, filed on 1 Sep. 2016, which is incorporated herein.

### TECHNICAL FIELD

The disclosed subject matter relates generally to the field of electronic communication management systems and methods employed thereof. More particularly, the present disclosure relates to the virtual home mailbox driven communication system and method for facilitating communications in real-time.

### BACKGROUND

Information technology is considered as a key catalyst and a single biggest differentiator in bringing business organizations and consumers closer through unique communication models. Many business organizations employ business applications, and in some cases, suites of business applications, to provide visibility of their presence and control various aspects of the business. For instance, the business organizations, may, include vendors, agents, service providers, offline physical retail outlets, online shopping stores, dealers, brokers, business leads, and the like. Typically, the business organizations are on the lookout for consumers and the consumers are on the lookout for the business organizations that can provide best services, better offers and meeting or exceeding their expectations. The consumers include customers, buyers, shoppers, purchasers, sales leads, and the like.

Due to limitations associated with rules and regulations, the business organizations restrict to operate within specific boundaries. Conventionally, the business organizations use a targeting strategy instead of hitting the resulting in extreme percentage of the digital and non-digital mail boxes filling with junk mails that are unattended and directly going to paper and digital trash wasting valuable natural and digital resources. Currently, the consumers face a big challenge of logging into innumerable specific line of business websites popping up every day to search for a service and product offerings thereby expending a lot of valuable time. Furthermore, the trend of web-portals for a specific line of business, where the consumer can go to the portal and submit what they want for a specific need is known. But, the same has not solved the problem completely as there are many portals for a specific line of business and new ones popping up, thereby making it difficult for the consumers and the business organizations to get the desired output.

Existing traditional targeting models can't bring into the process of business responding to the known specific request that enables to close the deal with the consumer and simultaneously compete with other business in real-time. There is no proper strategic plan of taking the household mail box into the virtual space and providing capability for solving consumers to business organizations, business organizations to consumers, business organizations to business organizations, and consumers to consumers.

In the light of aforementioned discussion, there exists a need for certain system with a novel methodology that would overcome the above-mentioned limitations.

### SUMMARY

An objective of the present disclosure is directed towards providing a secure virtual home mail box to establish communications between consumer to business organization, business organization to consumer, consumer to consumer and business organization to business organization.

Another objective of the present disclosure is directed towards enabling the business organizations to provide customized offers to the consumers and compete with other business organizations in real time.

Another objective of the present disclosure is directed towards validating and verifying consumers and business organizations to avoid misuse and scams.

Another objective of the present disclosure is directed towards enabling the business organizations to store metadata. The metadata may be related to products, offers, preferences, alerts, real time integration of products, and the like.

Another objective of the present disclosure is directed towards providing secured billing and payment gateway for completing business transactions.

Another objective of the present disclosure is directed towards shielding the identity of consumers for offers where consumer's identity is not needed.

Another objective of the present disclosure is directed towards receiving the requirement data from the consumers, identifying the suitable business organizations, alerting the business organizations, receiving and processing the customized responses from the business organizations and alerting the consumers.

Another objective of the present disclosure is directed towards communicating at a lightning speed with more efficiency to the consumers and the business organizations after taking physical address into the secure virtual network.

In one embodiment of the present disclosure, a system comprises a plurality of consumer computing devices and a plurality of business organization computing devices configured to create a plurality of virtual home mail boxes by a plurality of consumers and a plurality of business organizations with a virtual home mail box driven system, the created plurality of virtual home mail boxes are configured to allow a plurality of communications between the plurality of consumers to the plurality of business organizations, the plurality of business organizations to the plurality of consumers, the plurality of consumers to the plurality of consumers and the plurality of business organizations to the plurality of business organizations.

In another embodiment of the present disclosure, the virtual home mail box driven system further comprises of an offer managing module configured to capture a plurality of requests from the plurality of consumers and alert the plurality of consumers with a plurality of custom offers with and without geographic location limitations by a plurality of business organizations, wherein the plurality of business organizations are configured to reach out to the plurality of consumers with the plurality of custom offers through the offer managing module.

In another embodiment of the present disclosure, the virtual home mail box driven system further comprises of a digital home mail box providing module configured to deliver a plurality of secure mails to the plurality of consumer computing devices and the plurality of business organization computing devices.

In another embodiment of the present disclosure, the virtual home mail box driven system further comprises of a metadata providing module configured to provide metadata to the plurality of consumer computing devices and the plurality of business organization computing devices through the plurality of virtual home mail boxes, the metadata is collected by at least one database.

In another embodiment of the present disclosure, the virtual home mail box driven system further comprises of a common component assigning module configured to provide a foundation framework for generating at least one of a plurality of alerts, a plurality of rules, a plurality of reports and a plurality of analytics to the plurality of consumer computing devices and the plurality of business organization computing devices.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a diagram depicting an exemplary environment in which various embodiments disclosed herein may be implemented.

FIG. 2 is a block diagram depicting the virtual home mail box driven communication system 102 shown in FIG. 1, in accordance with one or more embodiments.

FIG. 3 is a flow diagram depicting a method for facilitating communications in real time, in accordance with one or more embodiments.

FIG. 4 is a flow diagram depicting method for processing business organization's access with the virtual home mail box driven communication system, in accordance with one or more embodiments.

FIG. 5 is a flow diagram depicting method for processing consumer's access with the virtual home mail box driven communication system, in accordance with one or more embodiments.

FIG. 6 is a flow diagram depicting method for establishing communications between the consumer to business organization and business organization to consumer, in accordance with one or more embodiments.

FIG. 7 is a flow diagram depicting method for establishing secure mail conversations between the consumer to business organization and business organization to consumer, in accordance with one or more embodiments.

FIG. 8 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

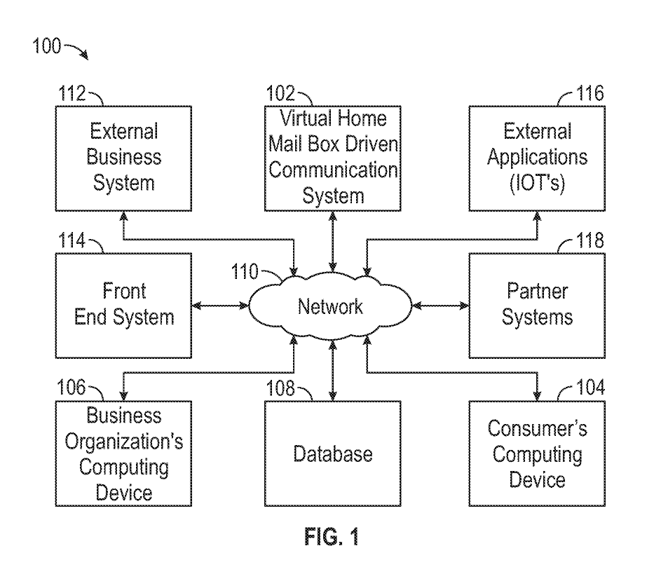

Referring now to the drawings wherein like numerals represent like elements throughout the several figures, FIG. 1 is a diagram depicting an exemplary environment 100 in which various embodiments disclosed herein may be implemented. Specifically, FIG. 1 depicts a schematic representation of environment 100 for facilitating communications. The environment 100 may depict a virtual home mail box driven communication system 102 connected to a consumer's computing device 104, a business organization's computing device 106 and a database 108 through a network 110. The network 110 may include, but not limited to, an ethernet, a wireless local area network (WLAN), or a wide area network (WAN), a WIFI communication network e.g., the wireless high speed internet, or a combination of networks, a cellular service such as a 4G (e.g., LTE, mobile WIMAX) or 5G cellular data service. The network 110 may provide a web interface/mobile interface employing transmission control protocol, hypertext transfer protocol, simple object access protocol or any other internet communication protocol. The network 110 may provide application programming interface or integration services. The virtual home mail box driven communication system 102 may be applications (e.g. software applications) accessed as mobile applications, software that offers the functionality of accessing mobile applications, and viewing/processing of interactive pages, for example, is implemented in the computing devices 104-106, as will be apparent to one skilled in the relevant arts by reading the disclosure provided herein.

The virtual home mail box driven communication system 102 may be architected as system as a service (SaaS) and may form a hub for facilitating communications in real-time between consumers to business organizations, business organizations to consumers, business organizations to business organizations, and the like. The virtual home mail box driven communication system 102 may include a disruptive model of breaking bands of traditional consumer to business organization, business organization to consumer, business organization to business organization, and consumer to consumer communication. The virtual home mail box driven communication system 102 may be configured to enable the consumers to create the virtual home mail boxes in the home. The virtual home mail box driven communication system 102 may be configured to provide the capability for the consumers and the business organizations to create virtual home mail boxes. The virtual home mail box may be graphically represented as an actual mailbox similar to real world mailboxes. The virtual home mail boxes are configured to allow communication between consumer to business organization, business organization to consumer, consumer to consumer and business organization to business organization, and the like. An individual's identity (for e.g., the identity may be consumer's identity or business organization's identity) may be an address. The address may include, but not limited to, physical address, and the like. The address may be taken into the secure virtual network provides unlimited opportunities for the house hold members (here, consumers) and business organizations to communicate in an efficient manner.

The consumer's computing device 104 and the business organization's computing device 106 may be configured to access the virtual home mail box driven communication system 102 after providing credentials by the consumer and the business organization respectively. The credentials may include a unique identifier or identifiers of the business organization or the consumer and a secured code that is shared between the business organizer or the consumer and the virtual home mail box driven communication system 102. For example identifiers may include, a username, an email address, an account identity, a mobile number, and the like. Example secured code associated with an identifier may include a password, a symmetric encryption key, biometric values, a passphrase, and the like.

The consumer's computing device 104 may be configured to receive address details given by the consumer on the virtual home mail box driven communication system 102. The business organization's computing device 106 may be configured to receive metadata provided by the business organization on the virtual home mail box driven communication system 102. Example of metadata may include, but not limited to, the business organization metadata, products metadata, services metadata, the consumer metadata, offer templates, and the like. The business organization's computing device 106 may also be configured to setup offers to the products and alert settings by the business organization on the virtual home mail box driven communication system 102. The business organization may configure the dashboard preferences on the virtual home mail box driven communication system 102. The business organization may also perform real time integrations on the virtual home mail box driven communication system 102. The database 108 may be configured to store data at the consumer level, consumer, business organizations, products and offering templates, and the like. The database 108 may include, but not limited to, a data warehouse (for e.g., OLAP (online analytical processing) database), OLTP (online transaction processing) database, and the like.

The virtual home mail box driven communication system 102 may be configured to integrate and communicate with disparate information systems internally and may also be configured to integrate with external business systems 112 and front end systems 114. The front end systems 114 may include, but not limited to, consumer web applications, consumer mobile applications, business organization web applications, business organization mobile applications, and the like. The front end systems 114, external applications 116, partner systems 118 may be configured to access the virtual home mail box driven communication system 102 through the application programming interfaces. The external applications 116 may include, but not limited to, IOT's, and the like. The frond end applications 114 may be configured to form the face to the virtual home mail box driven communication system 102 for providing real-time alerting display capabilities, consumer virtual home mail setup, accepting consumer requests, business product setup, displaying consumer virtual home mail box from unsecure offers to secure digital mail with online payment abilities. The virtual home mail box driven communication system 102 may be configured to incorporate various batch processes, real-time alert frameworks, application programming interface or integration layers, rules engine, data warehouse, and the like, for communications and integrations of the business organizations and consumers.

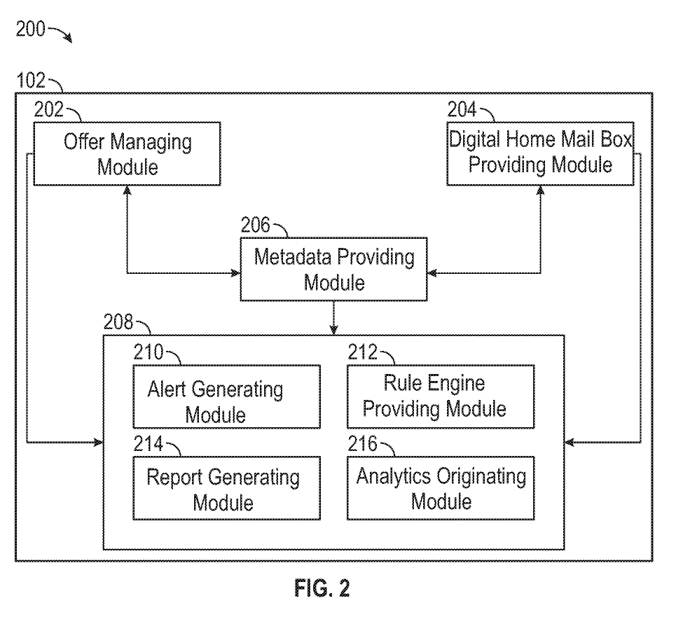

Referring to FIG. 2, FIG. 2 is a block diagram 200 depicting the virtual home mail box driven communication system 102 shown in FIG. 1, in accordance with one or more embodiments. The virtual home mail box driven communication system 102 may include an offer managing module 202, a digital home mail box providing module 204, a metadata providing module 206, a common component assigning module 208, and the like.

The offer managing module 202 may be configured to capture consumer's requests and alert the potential consumers of business organizations interested in quality products or services with discounts, with and without geographic location limitations. The offer managing module 112 may also be configured to enable the business organizations to reach out to the consumers with custom offerings. The offer managing module 202 may include an intelligent processing engine to filter in accordance with the consumers' strict requirement conditions. The offer managing module 202 may also be configured to provide a platform for business organizations to compete almost real-time to close the deal with the consumer. The digital home mail box providing module 204 may be configured for enabling secure mail communication between the business organizations to consumers, consumers to consumers, business organizations to business organizations, consumers to business organizations, and the like. The digital home mail box providing module 204 may be configured to deliver the secure mail to the consumer's mail box and the business organization's mail box. The secure mail may include, but not limited to, bills, secure digital mails, real-time utility or other related payment options, and the like. The digital home mail box providing module 204 may be configured to transform secure and unsecure paper mail transition to highly secure virtual home mail box of the consumer and the business organization. The digital home mail box providing module 204 may also be configured to facilitate instant secure mail communication.

The metadata providing module 206 may be configured to provide the metadata for the virtual home mail boxes of the consumer and the business organization. The metadata providing module 206 may be connected to the database 108 for collecting the metadata. The common component assigning module 208 may be configured to provide a foundation framework for generating alerts, rules, reports, and analytics. The common component assigning module 208 may also be configured to integrate with the offer managing module 202, the digital home mail box providing module 204, and the metadata providing module 206.

The common component assigning module 208 may further include an alert generating module 210, a rules engine providing module 212, a report generating module 214, an analytics originating module 216, and the like. The alert generating module 210 may be configured to send or receive real time alerts and responses to the business organizations and the consumers. The real time alerts may include, but not limited to, offer alerts, virtual mail alerts, consumer custom request alerts, responses, and the like. For example, the alert generating module is configured to send alerts to the consumer and post the custom business responses into the consumer's virtual home mail box in accordance with the consumer's request.

The rules engine providing module 212 may be configured to play a key role in enforcing the security and authorization work flow towards the consumer's virtual home mail box and the business organization's virtual home mail box. The rules engine providing module 212 may also be configured to process responses. The responses may include, but not limited to, consumers responses, business organizations responses, and the like. The report generating module 214 may be configured to generate reports to the business organizations and the consumers. The analytics originating module 216 may be configured to originate the analytics by the collected data from the database 108. The offer managing module 202 may be configured to responsible for consumer virtual mail setup, accepting consumer requests, sending or receiving real-time alerts and responses by the alert generating module 210.

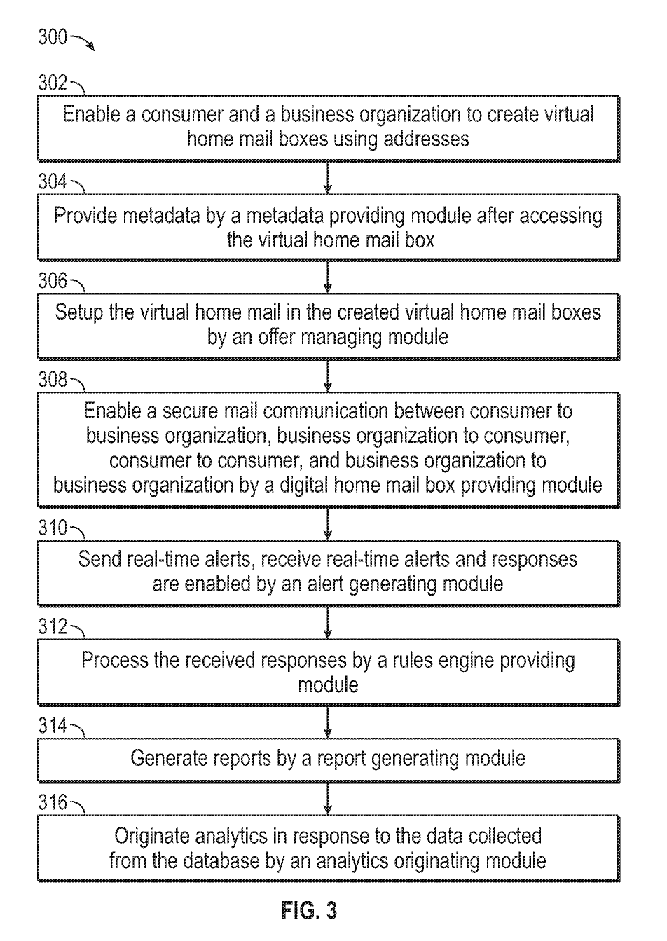

Referring to FIG. 3, FIG. 3 is a flow diagram 300 depicting method for facilitating communications in real time, in accordance with one or more embodiments. The method 300 may be carried out in the context of the details of FIG. 1, FIG. 2. However, method 300 may also be carried out in any desired environment, and it is pertinent to note that not all steps are mandatory or need to be performed in the same fashion (i.e., there is no implication of linearity in steps). Further, the aforementioned definitions may equally apply to the description below.

The method commences at step 302, the consumer and the business organization may be enabled to create virtual home mail boxes using the addresses. According to preferred embodiment, the metadata providing module may provide the metadata after accessing the virtual home mail box, at step 304. The offer managing module may setup the virtual mail in the created virtual home mail boxes, at step 306. The digital home mail box providing module may be configured to enable to secure mail communication between the consumer to business organization, business organization to consumer, consumer to consumer, and business organization to business organization, at step 308. According to another embodiment, the alert generating module may be configured to send real-time alerts, receive real-time alerts and responses, at step 310. According to another embodiment, the rules engine providing module may be configured to process the received responses, at step 312. According to another embodiment, the report generating module may generate reports, at step 314. According to another embodiment, the analytics originating module may originate the analytics in response to the data collected from the database, at step 316.

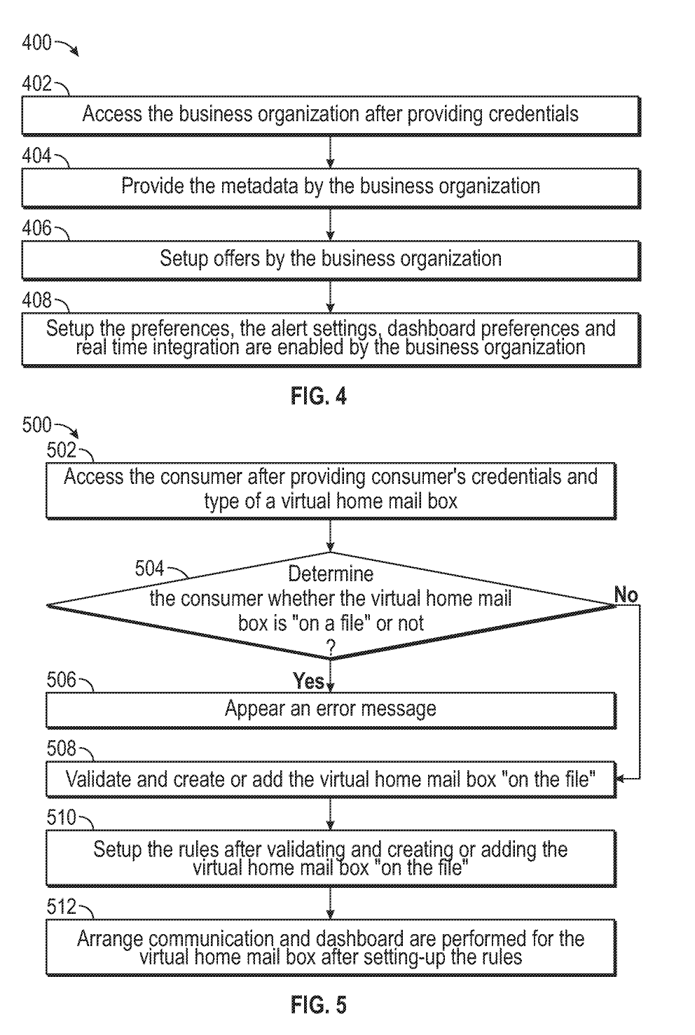

Referring to FIG. 4, FIG. 4 is a flow diagram 400 depicting method for processing business organization's access with the virtual home mail box driven communication system, in accordance with one or more embodiments. The method 400 may be carried out in the context of the details of FIG. 1, FIG. 2, and FIG. 3. However, method 400 may also be carried out in any desired environment, and it is pertinent to note that not all steps are mandatory or need to be performed in the same fashion (i.e., there is no implication of linearity in steps). Further, the aforementioned definitions may equally apply to the description below.

The method commences at step 402, the business organization may be allowed to access after providing the credentials. According to preferred embodiment, the metadata may be provided by the business organization, at step 404. According to another embodiment, the business organization may be allowed to setup offers, at step 406. Here, the offers may include, but not limited to, product offers, service offers, and the like. According to another embodiment, the business organization may be enabled to setup the preferences, the alert settings, dashboard preferences and real time integration, at step 408.

Referring to FIG. 5, FIG. 5 is a flow diagram 500 depicting method for processing consumer's access with the virtual home mail box driven communication system, in accordance with one or more embodiments. The method 500 may be carried out in the context of the details of FIG. 1, FIG. 2, FIG. 3, and FIG. 4. However, method 500 may also be carried out in any desired environment, and it is pertinent to note that not all steps are mandatory or need to be performed in the same fashion (i.e., there is no implication of linearity in steps). Further, the aforementioned definitions may equally apply to the description below.

The method commences at step 502, the consumer may be allowed to access after providing consumers credentials and the type of a virtual home mail box. Here, the consumer's credentials may include, but not limited to, consumer's address details, the like. The type of virtual home mail box may include, but not limited to, general virtual home mail box, secure virtual home mail box, and the like. According to preferred embodiment, the consumer may determine whether the virtual home mail box is on a file or not, at step 504, such as by performing a determination described above. If it indicates “on the file”, then an error message may appear, at step 506. If it is indicates “not on the file”, then validate and create or add the virtual home mail box on the file, at step 508. The rules may be setup after validating and creating or adding the virtual home mail box on the file, at step 510. Communication and dashboard may be arranged for the virtual home mail box after setting-up the rules, at step 512.

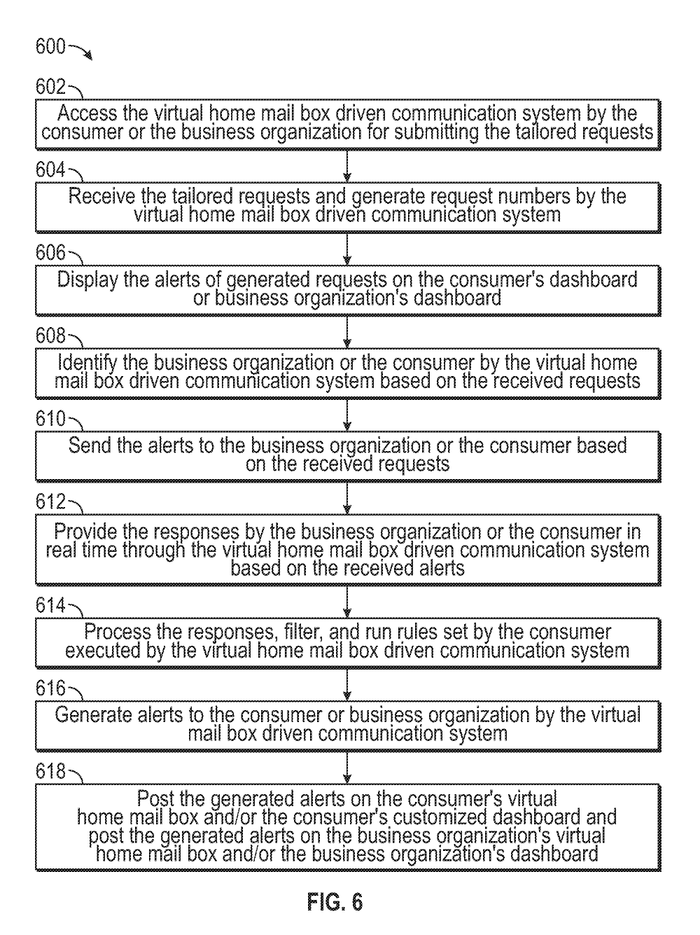

Referring to FIG. 6, FIG. 6 is a flow diagram 600 depicting method for establishing communication between the consumer to business organization and business organization to consumer, in accordance with one or more embodiments. The method 600 may be carried out in the context of the details of FIG. 1, FIG. 2, FIG. 3, FIG. 4, and FIG. 5. However, method 600 may also be carried out in any desired environment, and it is pertinent to note that not all steps are mandatory or need to be performed in the same fashion (i.e., there is no implication of linearity in steps). Further, the aforementioned definitions may equally apply to the description below.

The method commences at step 602, the consumer or business organization may be allowed to access the virtual home mail box driven communication system for submitting the tailored requests. The virtual home mail box driven communication system may be received the tailored requests and generate request numbers, at step 604. The alerts of generated requests may be displayed on the consumer's dashboards or business organization's dashboard, at step 606. The business organization or the consumer may be identified by the virtual home mail box driven communication system based on the received requests, at step 608. The alerts may be sent to the business organization or the consumer based on the received requests, at step 610. The responses may be provided by the business organization or the consumer in real time through the virtual home mail box driven communication system based on the received alerts, at step 612. The responses may be processed, filtered, and rules set by the consumer may be executed by the virtual home mail box driven communication system, at step 614. Alerts may be generated to the consumer or business organization by the virtual mail box driven communication system, at step 616. The generated alerts may be posted on the consumer's virtual home mail box and/or the consumer's customized dashboard and the generated alerts may be posted on the business organization's virtual home mail box and/or the business organization's dashboard, at step 618.

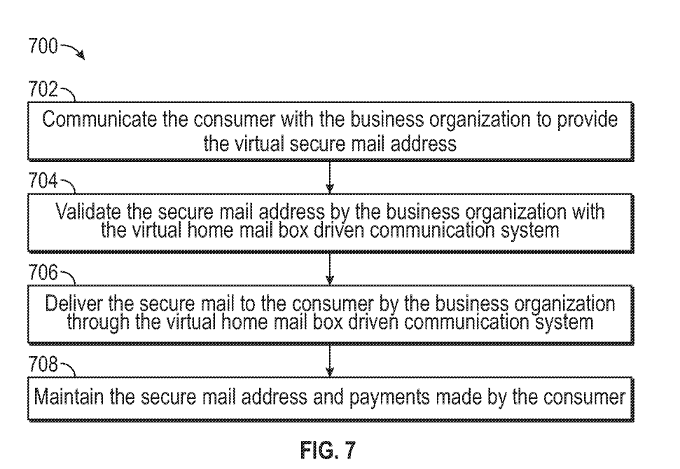

Referring to FIG. 7, FIG. 7 is a flow diagram 700 depicting method for establishing secure mail conversations between the consumer to business organization and business organization to consumer, in accordance with one or more embodiments. The method 700 may be carried out in the context of the details of FIG. 1, FIG. 2, FIG. 3, FIG. 4, and FIG. 5, and FIG. 6. However, method 700 may also be carried out in any desired environment, and it is pertinent to note that not all steps are mandatory or need to be performed in the same fashion (i.e., there is no implication of linearity in steps). Further, the aforementioned definitions may equally apply to the description below.

The method commences at step 702, consumer may communicate with the business organization to provide the virtual secure mail address. The business organization may validate the secure mail address with the virtual home mail box driven communication system, at step 704. The secure mail may be delivered to the consumer by the business organization through the virtual home mail box driven communication system, at step 706. Here, the consumer dashboard may have the organized dashboard with past communications. The secure mail address may be maintained and payments made by the consumer, at step 708.

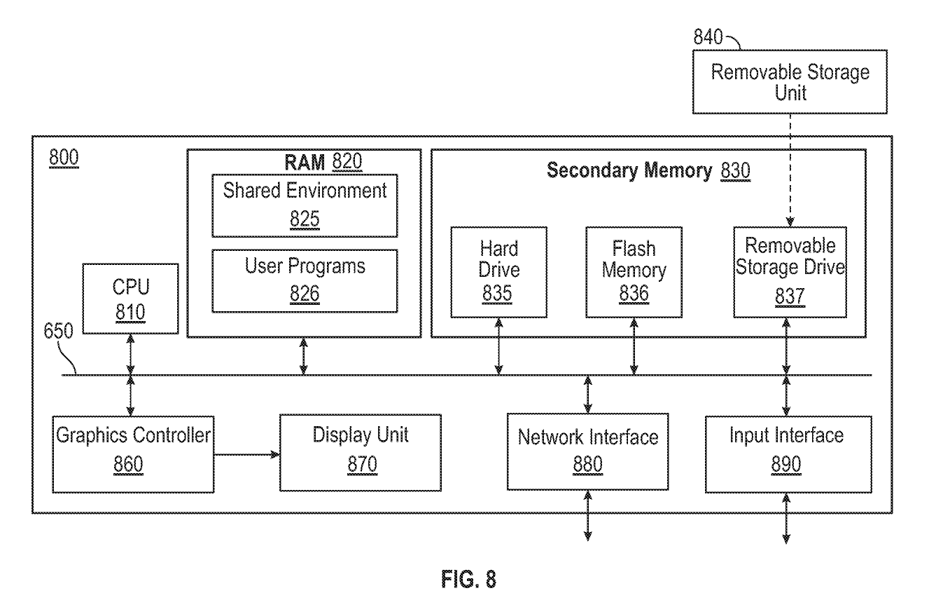

Referring to FIG. 8, FIG. 8 is a block diagram 800 illustrating the details of a digital processing system 800 in which various aspects of the present disclosure are operative by execution of appropriate software instructions. The Digital processing system 800 may correspond to the computing devices 104, and 106 (or any other system in which the various features disclosed above can be implemented).

Digital processing system 800 may contain one or more processors such as a central processing unit (CPU) 810, random access memory (RAM) 820, secondary memory 827, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions, such as those used in threads and stacks, constituting shared environment 825 and/or user programs 826. Shared environment 825 includes operating systems, device drivers, virtual machines, etc., which provide a (common) run time environment for execution of user programs 826.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems (such as those shown in FIG. 1, network 108) connected to the network.

Secondary memory 830 may contain hard drive 835, flash memory 836, and removable storage drive 837. Secondary memory 830 may store the data software instructions (e.g., for performing the actions noted above with respect to the Figures), which enable digital processing system 500 to provide several features in accordance with the present disclosure.

Some or all of the data and instructions may be provided on removable storage unit 540, and the data and instructions may be read and provided by removable storage drive 837 to CPU 810. Floppy drive, magnetic tape drive, CD-ROM drive, DVD Drive, Flash memory, removable memory chip (PCMCIA Card, EEPROM) are examples of such removable storage drive 837.

Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 830. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. A system for facilitating communications in real time, comprising:
a plurality of consumer computing devices and a plurality of business organization computing devices configured to create a plurality of virtual home mail boxes by a plurality of consumers and a plurality of business organizations with a virtual home mail box driven system, wherein the created plurality of virtual home mail boxes are configured to allow a plurality of communications between the plurality of consumers to the plurality of business organizations, the plurality of business organizations to the plurality of consumers, the plurality of consumers to the plurality of consumers and the plurality of business organizations to the plurality of business organizations; wherein the virtual home mail box driven system further comprises of:
an offer managing module configured to capture a plurality of requests from the plurality of consumers and alert the plurality of consumers with a plurality of custom offers with and without geographic location limitations by a plurality of business organizations, wherein the plurality of business organizations are configured to reach out to the plurality of consumers with the plurality of custom offers through the offer managing module;
a digital home mail box providing module configured to deliver a plurality of secure mails to the plurality of consumer computing devices and the plurality of business organization computing devices;
a metadata providing module configured to provide metadata to the plurality of consumer computing devices and the plurality of business organization computing devices through the plurality of virtual home mail boxes, whereby the metadata is collected by at least one database; and
and a common component assigning module configured to provide a foundation framework for generating at least one of a plurality of alerts, a plurality of rules, a plurality of reports and a plurality of analytics to the plurality of consumer computing devices and the plurality of business organization computing devices.

2. The system of claim 1, wherein the common component assigning module further comprising at least one alert generating module configured to send and receive the plurality of real time alerts and a plurality of responses to the plurality of business organization computing devices and the plurality of consumer computing devices.

3. The system of claim 1, wherein the common component assigning module further comprising at least one rules engine providing module configured to process the plurality of responses.

4. The system of claim 1, wherein the common component assigning module further comprising at least one report generating module configured to generate the plurality of reports to the plurality of consumer computing devices and the plurality of business organization computing devices.

5. The system of claim 1, wherein the common component assigning module further comprising at least one analytics originating module configured to originate the plurality of analytics by the collected data from the database.

6. The system of claim 1, wherein the plurality of consumer computing devices and the business organization computing devices are configured to access the virtual home mail box driven communication system after providing a plurality of credentials by the plurality of consumers and the plurality of business organizations.

7. The system of claim 1, further comprises a plurality of external business systems and a plurality of front end systems, a plurality of partner systems, and a plurality of external applications are integrated with the virtual home mail box driven communication system.

8. The system of claim 7, wherein the plurality of front end applications are configured to form a face to the virtual home mail box driven communication system for providing at least one of: real-time alerting display capabilities, consumer virtual home mail setup, accepting a plurality of consumer requests, business product setup, displaying consumer virtual home mail box from unsecure offers to secure digital mail with online payment abilities.

9. A method for facilitating communications in real time, comprising:
enabling a plurality of consumers and a plurality of business organizations to create a plurality of virtual home mail boxes, whereby the plurality of virtual home mail boxes are created by addresses of the plurality of consumers and the plurality of business organizations; providing metadata to the plurality of consumers and the plurality of business organizations by a metadata providing module after accessing a plurality of virtual home mail boxes; setting-up a plurality of virtual mails in the created virtual home boxes by an offer managing module, wherein the offer managing module enabling to capture a plurality of requests from the plurality of consumers and alerting the plurality of consumers with a plurality of custom offers; allowing a digital home mail box providing module to deliver a plurality of secure mails between the plurality of consumers to the plurality of business organizations, the plurality of business organizations to the plurality of consumers, the plurality of consumers to the plurality of consumers, and the plurality of business organizations to the plurality of business organizations; enabling an alert generating module to send and receive a plurality of real-time alerts, and a plurality of responses; processing the plurality of responses by a rules engine providing module; generating a plurality of reports by a report generating module; and originating a plurality of a analytics in response to data collected from a database.

10. The method of claim 9, further comprising a step of accessing a virtual home mail box driven communication system after providing a plurality of credentials by the plurality of business organizations,
providing metadata by the plurality of business organizations;
allowing the plurality of business organizations to setup a plurality of offers; and
enabling the plurality of business organizations to setup at least one of: a plurality of preferences, a plurality of alert settings, a plurality of dashboard preferences and a plurality of real time integrations.

11. The method of claim 9, further comprising a step of accessing a virtual home mail box driven communication system after providing a plurality of credentials by the plurality of consumers,
providing a type of virtual home mail boxes by the plurality of consumers;
validating, creating and adding the plurality of virtual home mail boxes on a plurality of files by the plurality of consumers;
setting-up a plurality of rules after validating, creating and adding the plurality of virtual home mail boxes on the plurality of files by the plurality of consumers; and
setting-up a plurality of communications, a plurality of dashboards, and a plurality of preferences by the plurality of consumers.

12. The method of claim 9, further comprising a step of submitting a plurality of tailored requests by the plurality of consumers and the plurality of business organizations.

13. The method of claim 9, further comprising a step of generating a plurality of request numbers.

14. The method of claim 9, further comprising a step of displaying a plurality of alerts of generated requests on a plurality of consumer dashboards, and a plurality of business organization dashboards.

15. The method of claim 9, further comprising a step of validating a plurality of mail addresses.

16. The method of claim 9, further comprising a step of providing a plurality of responses by the plurality of business organizations and the plurality of consumers.

17. The method of claim 9, further comprising a step of posting the plurality of generated alerts on the plurality of virtual home mail boxes and the plurality of dashboards.

18. The method of claim 9, further comprising a step of processing the plurality of responses, filtering, and setting rules.

19. The method of claim 9, further comprising a step of maintaining the plurality of mail addresses and making a plurality of payments.

20. A computer program product comprising module code embedded in a non-transitory data storage medium, wherein execution of the module code on a computing device causes the computing device to:
enable a plurality of consumers and a plurality of business organizations to create a plurality of virtual home mail boxes, whereby the plurality of virtual home mail boxes are created by addresses of the plurality of consumers and the plurality of business organizations;
provide metadata to the plurality of consumers and the plurality of business organizations by a metadata providing module after accessing a plurality of virtual home mail boxes;
set-up a plurality of virtual mails in the created virtual home boxes by an offer managing module, wherein the offer managing module enabling to capture a plurality of requests from the plurality of consumers and alerting the plurality of consumers with a plurality of custom offers;
allow a digital home mail box providing module to deliver a plurality of secure mails between the plurality of consumers to the plurality of business organizations, the plurality of business organizations to the plurality of consumers, the plurality of consumers to the plurality of consumers, and the plurality of business organizations to the plurality of business organizations;
enable an alert generating module to send and receive a plurality of real-time alerts, and a plurality of responses; and
process the plurality of responses by a rules engine providing module; generating a plurality of reports by a report generating module; and originate a plurality of a analytics in response to data collected from a database.
